(19) United States
(12) Patent Application Publication
(10) Pub. No.: US 2023/0127196 A1
(43) Pub. Date: Apr. 27, 2023

(54) PNEUMATIC MOTION SYSTEM

(71) Applicants: Huan-Chang Kuan, Pingtung County (TW); FU-GUAN-DA CO., LTD., Pingtung County (TW)

(72) Inventor: Huan-Chang KUAN, Pingtung County (TW)

(73) Assignees: Huan-Chang Kuan, Pingtung County (TW); FU-GUAN-DA CO., LTD., Pingtung County (TW)

(21) Appl. No.: 17/729,570

(22) Filed: Apr. 26, 2022

(30) Foreign Application Priority Data
Oct. 27, 2021 (TW) 110139892

(51) Int. Cl. F03D 9/17; F03D 9/16; F03D 80/70

(52) U.S. Cl. CPC F03D 9/17; F03D 9/16; F03D 80/70; F05B 2260/50; F05B 2260/60; F05B 2260/98; F05B 2260/422

(57) ABSTRACT

A pneumatic motion system includes a plurality of casings, a plurality of frame members respectively extending into the casings, a plurality of linear rails respectively mounted to the frame members, a plurality of main weight members respectively and movably mounted to the linear rails, at least one air supply member, and pairs of main air compressors. Each pair of the main air compressors is disposed at one of two opposite ends of a respective one of the casings. For each casing, when the respective one of the main weight members is moved to the one of the opposite ends of the casing, each pair of the main air compressors is pressed by the main weight member to force air into the at least one air supply member.

### CROSS-REFERENCE TO RELATED APPLICATION

This application claims priority to Taiwanese Invention Patent Application No. 110139892, filed on Oct. 27, 2021.

### FIELD

The disclosure relates to a motion system, and more particularly to a pneumatic motion system.

### BACKGROUND

Generally, a conventional motion system converts potential energy into kinetic energy and drives an apparatus with the kinetic energy. However, the medium involved in the conversion in the conventional motion system may not be environmentally friendly. To meet increasing environmental awareness concerns, a sustainable medium (e.g., air) which has low environmental impact needs to be adopted for the conversion.

In addition, during the conversion, a portion of the kinetic energy converted from other energy may normally be wasted. In order to reduce the waste of energy, and to incorporate eco-friendly features, the conventional motion system should be further improved.

### SUMMARY

Therefore, an object of the disclosure is to provide a pneumatic motion system that is further improved.

According to the disclosure, the pneumatic motion system includes a base unit, a rotating unit, a plurality of shifting units, an actuator unit and a plurality of air cycle units. The rotating unit is rotatably mounted to the base unit, and includes a rotating wheel, a plurality of casings and a plurality of frame members. The rotating wheel is rotatable relative to the base unit about an axis. The casings are mounted to the rotating wheel and are angularly spaced apart from each other about the axis. Each of the casings defines a casing space therein. Each of the frame members is mounted to the rotating wheel, and extends in a direction different from a radial direction of the rotating wheel into the casing space of a respective one of the casings. Each of the shifting units includes a linear rail and a hollow main weight member that is movably mounted to the linear rail. The linear rail of each of the shifting units is mounted to a respective one of the frame members and extends along the respective one of the frame members. The main weight member of each of the shifting units is located in the casing space of a respective one of the casings, defines a lubrication space that is adapted for storing a lubricant therein, and has at least one lubricant outlet opening that fluidly communicates with the lubrication space and that opens toward the linear rail such that the lubricant lubricates the linear rail. The actuator unit is connected to the shifting units, and includes a plurality of pneumatic cylinders, at least one air supply member, and a controller. The main weight member of each of the shifting units is connected to at least one of the pneumatic cylinders. The at least one air supply member fluidly communicates with the pneumatic cylinders. The controller is signally coupled to the pneumatic cylinders and is operable to control the pneumatic cylinders to urge the main weight members of the shifting units to respectively move along the linear rails of the rotating unit so as to shift a center of gravity of an assembly of the rotating unit and the shifting units away from the axis. Each of the air cycle units is disposed at one of two opposite ends of a respective one of the casings of the rotating unit, and includes two main air compressors that are spaced apart from each other and that fluidly communicate with the at least one air supply member of the actuator unit. For each casing of the rotating unit, when the main weight member of the respective one of the shifting units is moved to the one of the opposite ends of the casing, each of the main air compressors is pressed by the main weight member to force air into the at least one air supply member.

### BRIEF DESCRIPTION OF THE DRAWINGS

Other features and advantages of the disclosure will become apparent in the following detailed description of the embodiment with reference to the accompanying drawings, of which:

FIG. 1 is a front view of an embodiment of a pneumatic motion system according to the disclosure;

FIG. 2 is a fragmentary, enlarged sectional view illustrating a shifting unit of the embodiment;

FIG. 3 is a fragmentary, enlarged sectional view illustrating a main weight member of the shifting unit;

FIG. 4 is a fragmentary, schematic view illustrating an actuator unit of the embodiment;

FIG. 5 is a fragmentary, front view illustrating connections between a rotor of the embodiment and a plurality of pneumatic cylinders of the actuator unit;

FIG. 6 is a fragmentary, enlarged sectional view illustrating an air cycle unit of the embodiment;

FIG. 7 is a schematic view illustrating a main weight member of the shifting unit moving along a linear rail of the shifting unit when the shifting unit is at different angular positions;

FIG. 8 is a schematic view illustrating a lubricant in the main weight member of the shifting unit lubricating the linear rail of the shifting unit through a lubricant outlet opening of the main weight member;

FIG. 9 is a fragmentary, schematic view illustrating the main weight member of the shifting unit pressing main air compressors of a respective one of the air cycle units; and

FIG. 10 is a flowchart illustrating the circulation of air in the embodiment.

### DETAILED DESCRIPTION

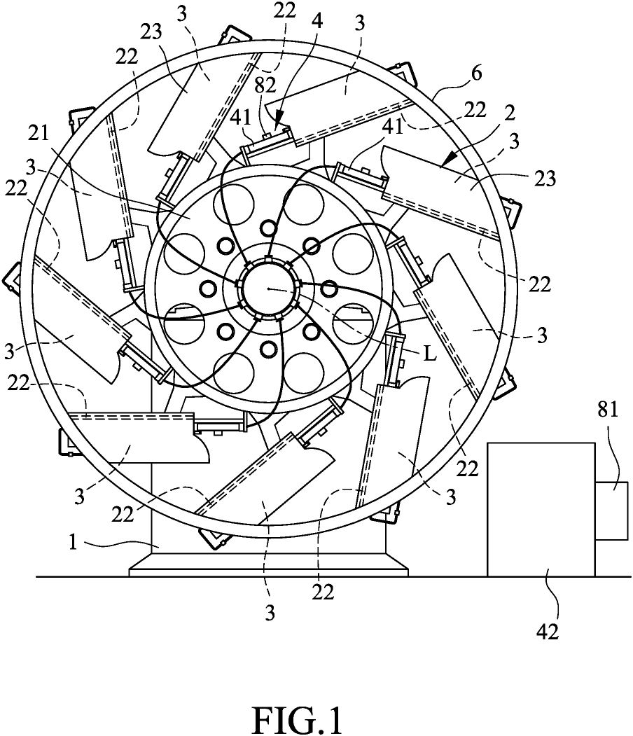

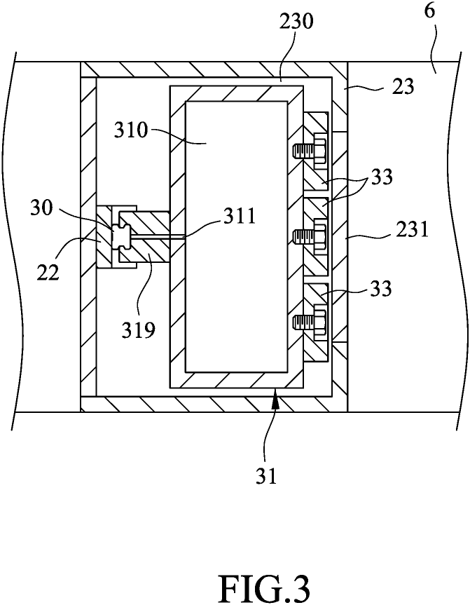

Referring to FIGS. 1 to 3, an embodiment of a pneumatic motion system includes a base unit 1, a rotating unit 2, nine shifting units 3, an actuator unit 4, a plurality of air cycle units 5, and a communicating unit 6. The rotating unit 2 is rotatably mounted to the base unit 1, and includes a rotating wheel 21, nine casings 23 and nine frame members 22. The shifting units 3 are respectively disposed on the frame members 22 of the rotating unit 2. The base unit 1 is preferably disposed on a location that is stable to prevent the rotating unit 2 and the shifting units 3 from shaking when in operation, so the operational stability of the pneumatic motion system is ensured. In addition, when the dimensions of the pneumatic motion system are relatively large, structural foundations may be set up for the base unit 1 to be disposed on to further enhance the operational stability of the pneumatic motion system.

The rotating wheel 21 of the rotating unit 2 is rotatable relative to the base unit 1 about an axis (L). In this embodiment, the axis (L) is horizontal. The casings 23 of the rotating unit 2 are mounted to the rotating wheel 21 and are angularly spaced apart from each other about the axis (L). Specifically, the casings 23 are equiangularly spaced apart from each other about the axis (L) (i.e., two adjacent ones of the casings 23 cooperate with the axis (L) to define a 40-degree central angle whose apex is located at a center of the rotating wheel 21 on the axis (L)). It is noted that, the number of the casings 23 may not be limited to nine as long as the number is odd and larger than one. The number of the wheel rods 22 of the rotating unit 2 is equal to that of the casings 23. Each of the casings 23 defines a casing space 230 therein. Each of the frame members 22 is mounted to the rotating wheel 21 and extends in a direction different from a radial direction of the rotating wheel 21 into the casing space 230 of a respective one of the casings 23. Each of the casings 23 has two opposite ends that are respectively proximate to and distal from the rotating wheel 21, and includes a window 232 that is close to one of the opposite ends distal from the rotating wheel 21, and that is configured to be made of a transparent material.

Each of the shifting units 3 includes a linear rail 30, a main weight member 31, two lubricant seals 32 and at least one auxiliary weight member 33. In this embodiment, each of the shifting units 3 includes three auxiliary weight members 33. The linear rail 30 is mounted to a respective one of the frame members 22 of the rotating unit 2 and extends along the respective one of the frame members 22. The main weight member 31 is configured to be hollow, is movably mounted to the linear rail 30, is located in the casing space 230 of a respective one of the casings 23 of the rotating unit 2, defines a lubrication space 310 that is adapted for storing a lubricant therein, and has a lubricant outlet opening 311, a lubricant inlet opening 312, a lid 313 and a sliding block section 319. The lubricant outlet opening 311 fluidly communicates with the lubrication space 310 and opens toward the linear rail 30 such that the lubricant lubricates the linear rail 30. Through the lubricant inlet opening 312 of each of the main weight members 31, the lubrication space 310 of the main weight member 31 communicates with the external environment (i.e., the casing space 230 of the respective one of the casings 23). The lid 313 removably blocks the lubricant inlet opening 312. When the lubricant in the lubrication space 310 of each of the main weight members 31 has to be replenished, or has to be replaced with another lubricant, the lid 313 of the main weight member 31 is operable to be opened so the lubricant may be drained from the lubrication space 310 through the lubricant inlet opening 312 of the main weight member 31 and another lubricant can be filled in the lubrication space 310 of the main weight member 31 through the lubricant inlet opening 312 of the main weight member 31. For each shifting unit 3, the sliding block section 319 protrudes away from the lubrication space 310 and is slidably mounted to the linear rail 30. In this embodiment, the lubricant outlet opening 311 of each of the main weight members 31 extends through the sliding block section 319 of the main weight member 31. The auxiliary weight members 33 are removably attached to the main weight member 31. Each of the casings 23 further includes a gate member 231 that is located adjacent to the path of movement of the main weight member 31 of the respective one of the shifting units 3, and that is operable to open such that the auxiliary weight members 33 of the respective one of the shifting units 3 are accessible.

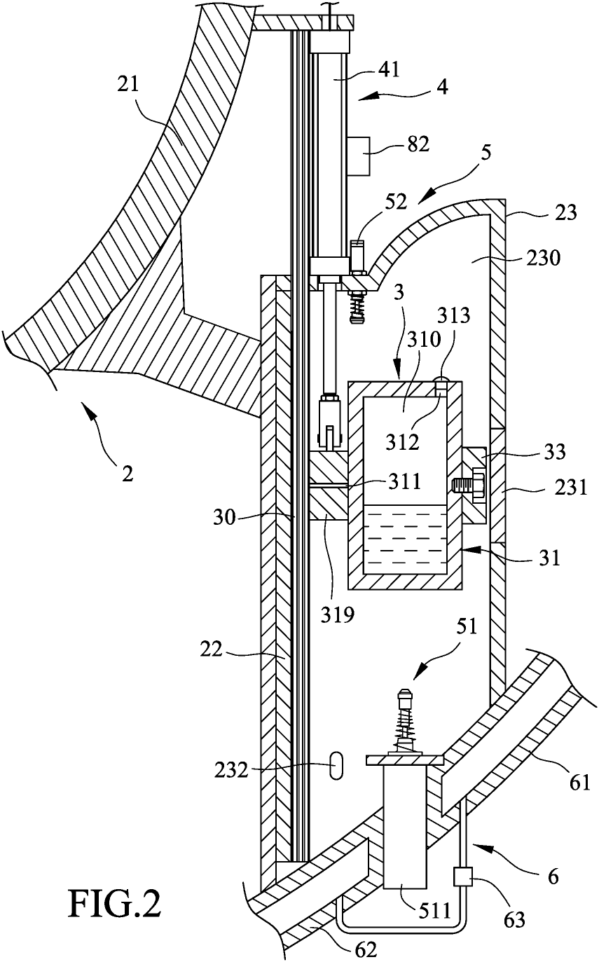

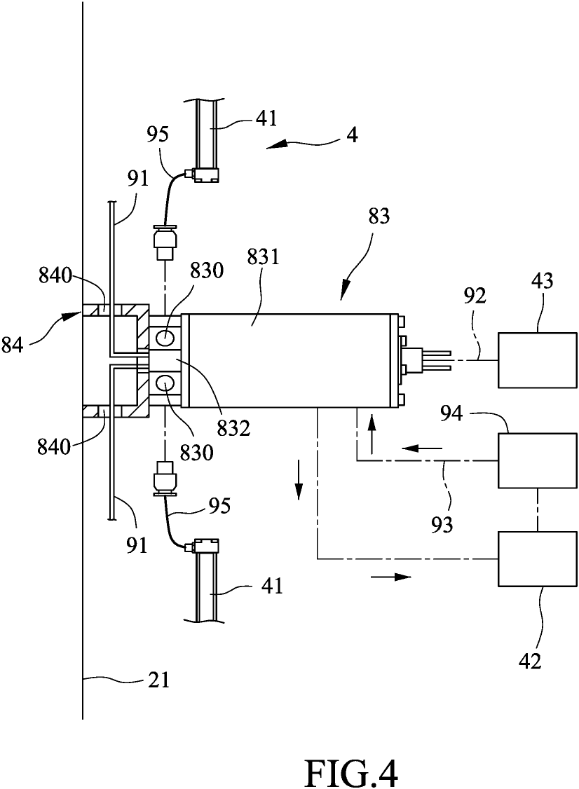

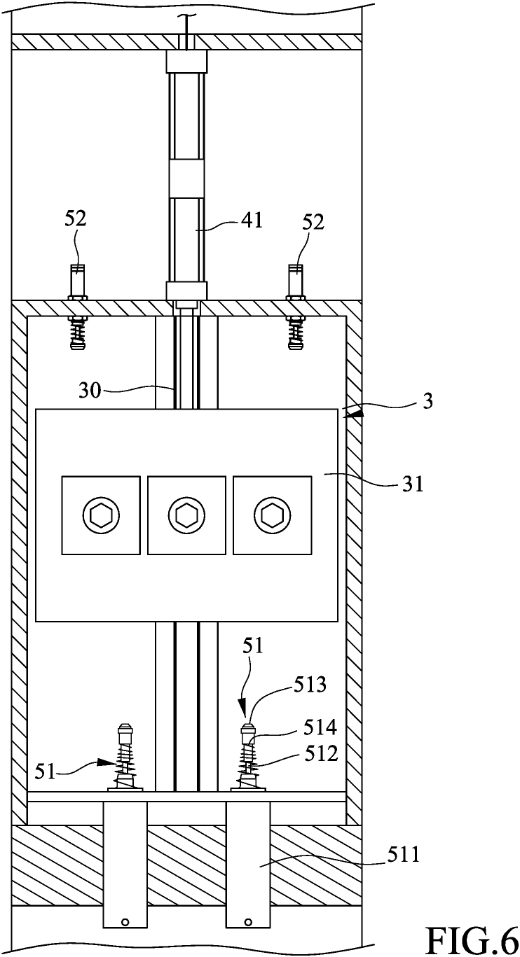

Referring further to FIGS. 4 and 6, the actuator unit 4 is connected to the shifting units 3 (only one of the shifting units 3 is shown in FIG. 2), and includes a plurality of pneumatic cylinders 41, an air supply member 42 and a controller 43. The main weight member 31 of each of the shifting units 3 is connected to at least one of the pneumatic cylinders 41. In this embodiment, the main weight member 31 of each of the shifting units 3 is connected to a respective one of the pneumatic cylinders 41. The air supply member 42 fluidly communicates with the pneumatic cylinders 41. The controller 43 is signally coupled to the pneumatic cylinders 41 and is operable to control the pneumatic cylinders 41 to urge the main weight members 31 of the shifting units 3 to respectively move along the linear rails 30 of the shifting units 3 so as to shift a center of gravity of an assembly of the rotating unit 2 and the shifting units 3 away from the axis (L). When the center of gravity of the assembly of the rotating unit 2 and the shifting units 3 is shifted, the rotating unit 2 rotates relative to the base unit 1 about the axis (L). Because the shifting units 3 are respectively disposed on the frame members 22, the shifting units 3 co-rotate with the frame members 22 about the axis (L) when the rotating unit 2 rotates about the axis (L). By virtue of the number of the casings 23 of the rotating unit 2 being odd, the center of gravity of the assembly of the rotating unit 2 and the shifting units 3 can be shifted relatively easily (i.e., the rotating unit 2 tends to rotate).

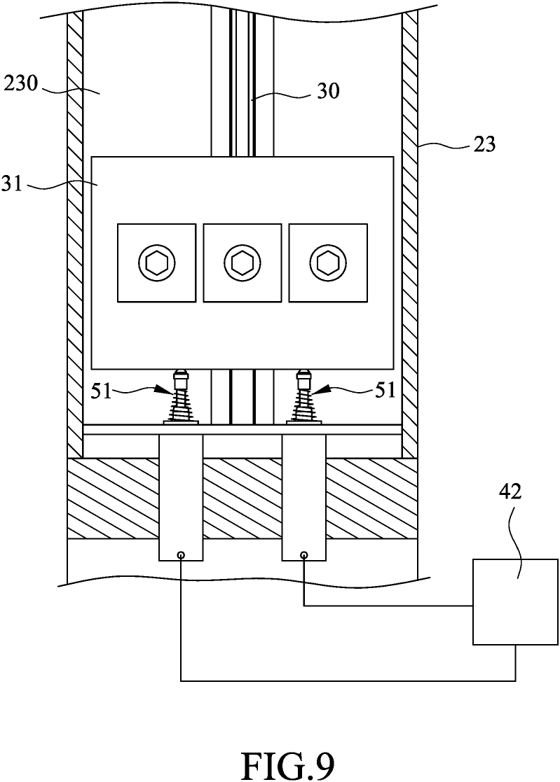

Each of the air cycle units 5 is disposed at one of two opposite ends of a respective one of the casings 23 of the rotating unit 2 and includes two main air compressors 51. The main air compressors 51 are spaced apart from each other and fluidly communicate with the air supply member 42 of the actuator unit 4 (see FIG. 9). For each casing 23 of the rotating unit 2, when the main weight member 31 of the respective one of the shifting units 3 is moved to the one of the opposite ends of the casing 23, each of the main air compressors 51 is pressed by the main weight member 31 to force air into the air supply member 42. Specifically, each of the main air compressors 51 includes a main body 511, a push rod 512, a contact member 513 and an elastic member 514. The main body 511 includes a piston therein (not shown). For each main air compressor 51, the push rod 512 extends from the main body 511 toward the other one of the opposite ends of the respective one of the casings 23. The contact member 513 is disposed on one end of the push rod 512 opposite to the main body 511. The elastic member 514 is sleeved on the push rod 512 and has two opposite ends that respectively abut against the main body 511 and the contact member 513. For each casing 23 of the rotating unit 2, when each of the main air compressors 51 is pressed by the main weight member 31 of the respective one of the shifting units 3, the push rod 512 of the main air compressor 51 is pushed toward the main body 511 of the main air compressor 51, and the elastic member 514 of the main air compressor 51 is compressed and provides a restoring force for the push rod 512 to move away from the main body 511. For each air cycle unit 5, the contact members 513 are in contact with the main weight member 31 of the respective one of the shifting units 3 when the main air compressors 51 are pressed by the main weight member 31 of the shifting unit 3. For each main air compressor 51, when the push rod 512 is pushed toward the main body 511, the piston in the main body 511 is pushed and air is forced into the air supply member 42. For each main air compressor 51, when the push rod 512 is moved away from the main body 511 by the restoring force provided by the elastic member 514, air is sucked into the main body 511. The pneumatic motion system may further include a plurality of bump stops 52 each of which is disposed at the other one of the opposite ends of a respective one of the casings 23. In this embodiment, each of the casings 23 is provided with two bump stops 52 (see FIG. 6). Each of the bump stops 52 may be configured as, but not limited to, a hydraulic bump stop, a hydraulic shock absorber in conjunction with a pneumatic spring, or a damper. For each casing 23 of the rotating unit 2, when the main weight member 31 of the respective one of the shifting units 3 is moved to the other one of the opposite ends of the wheel rod 22, the bump stops 52 reduce the shock impulse of the main weight member 31 of the shifting unit 3.

The communicating unit 6 surrounds the axis (L), is mounted to the casings 23 of the rotating unit 2, is connected to the air cycle units 5, and includes a plurality of first air tubes 61 (only one is shown in FIG. 2) and a plurality of second air tubes 62 (only one is shown in FIG. 2). The first air tubes 61 fluidly communicate with the main air compressors 51 of the air cycle units 5 and the air supply member 42 of the actuator unit 4. The second air tubes 62 fluidly communicate with the air compressors 51 and the pneumatic cylinders 41 of the actuator unit 4. The first air tubes 61 and the second air tubes 62 are arranged in an alternating arrangement. For each air cycle unit 5, when the main air compressors 51 are pressed, air in the main air compressors 51 is forced to pass through the first air tubes 61 before entering the air supply member 42. For each main air compressor 51, the main air compressors 51 suck air out of the second air tubes 62 when the push rods 512 are moved away from the main bodies 511. The communicating unit 6 further includes a plurality of check valves 63 (only one is shown in FIG. 2). Each of the check valves interconnects a respective one of the first air tubes 61 and the respective one of the second air tubes 62, and prevents air from flowing from the respective one of the first air tubes 61 to the respective one of the second air tubes 62 (i.e., the air in the communicating units 6 is allowed to flow only in one direction). That is to say, for each air cycle unit 5, the air that is in the second air tubes 62 is sucked and then forced into the air supply member 42 through the first air tubes 61 by the main air compressors 51. In this embodiment, the first air tubes 61 and the second air tubes 62 are configured to be cooperatively formed in an annular shape. By virtue of the communicating unit 6 being mounted to the casings 23, the rotating unit 2 is prevented from shaking when the pneumatic motion system is in operation.

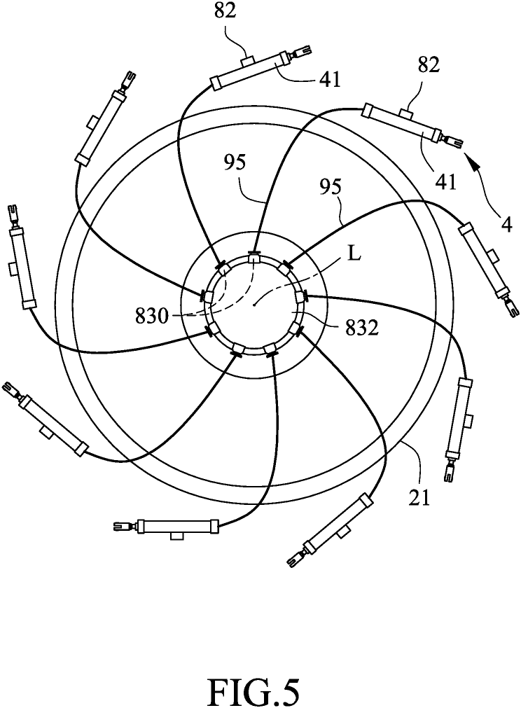

Referring further to FIG. 5, in cooperation with FIGS. 1 and 4, the pneumatic motion system further includes an auxiliary air compressor 81, a plurality of solenoid valves 82, a rotary union 83, a union seat 84, a plurality of first wires 91, a second wire 92, a first air-supply line 93, a plurality of second air-supply lines 95 and an oil-air distributor 94. The air supply member 42 of the actuator unit 4 stores air used for the operation of the pneumatic cylinders 41 of the actuator unit 4. When the air in the pneumatic cylinders 41 is insufficient for the operation of the pneumatic cylinders 41, the auxiliary air compressor 81 allows the air supply member 42 to supply the air stored in the air supply member 42 to the pneumatic cylinders 41. The oil-air distributor 94 fluidly communicates with the air supply member 42. After the air leaves the air supply member 42, the air enters the oil-air distributor 94. The oil-air distributor 94 adds a proper amount of oil (i.e., another lubricant) to the air therein, and distributes the aerosol (i.e., the blended air and oil).

The rotary union 83 is signally coupled to the controller 43 of the actuator unit 4 through the second wire 92, and includes a stator 831 and a rotor 832. The air-supply line 93 interconnects the air supply member 42, the oil-air distributor 94 and the stator 831 to allow fluid communication among the air supply member 42, the oil-air distributor 94 and the stator 831. After being distributed by the oil-air distributor 94, the aerosol enters the stator 831 through the air-supply line 93. The rotor 832 is rotatable relative to the stator 831, is mounted to the union seat 84, fluidly communicates with the first air tubes 61 of the communicating unit 6 and the stator 831, and has a plurality of air holes 830. Each of the second air-supply lines 95 fluidly communicates with a respective one of the air holes 830 and a respective one of the pneumatic cylinders 41. The union seat 84 is substantially annular, is mounted to the rotating wheel 21 of the rotating unit 2 (i.e., the union seat 84 interconnects the rotating wheel 21 and the rotor 832), surrounds the axis (L), and has a plurality of wire holes 840 each of which extends through the union seat 84 in a radial direction of the union seat 84. Each of the first wires 91 extends through a respective one of the wire holes 840 and electrically interconnects a respective one of the solenoid valves 82 and the rotary union 83. The auxiliary air compressor 81 is operable to urge the aerosol that enters the stator 831 to flow into the pneumatic cylinders 41 sequentially through the air holes 830 of the rotor 832 and through the second air-supply lines 95, so as to supply the air to the pneumatic cylinders 41. The controller 43 is operable to either allow or cease the fluid communication between the air supply member 42 and the stator 831 to control the pneumatic cylinders 41. Each of the solenoid valves 82 is signally coupled to a respective one of the pneumatic cylinders 41, is operable to either allow or cease the fluid flow in the respective one of the pneumatic cylinders 41, and is powered by direct current. By virtue of the solenoid valves 82 being powered by direct current, the solenoid valves 82 may swiftly allow or cease the fluid flows in the pneumatic cylinders 41, and each of the main weight members 31 of the shifting units 3 may be swiftly actuated to move according to operational requirements to ensure the pneumatic motion system is functional. When the rotating wheel 21 rotates, the pneumatic cylinders 41 co-rotate with the rotating wheel 21 about the axis (L). By virtue of the pneumatic motion system including the rotary union 83, when the rotating wheel 21 rotates, the rotor 832 of the rotary union 83 and the second air-supply lines 95 co-rotate with the pneumatic cylinders 41 about the axis (L). Thus, when the rotating wheel 21 rotates, the second air-supply lines 95 will not entangle with each other, which prevents air supply interruption to the pneumatic cylinders 41.

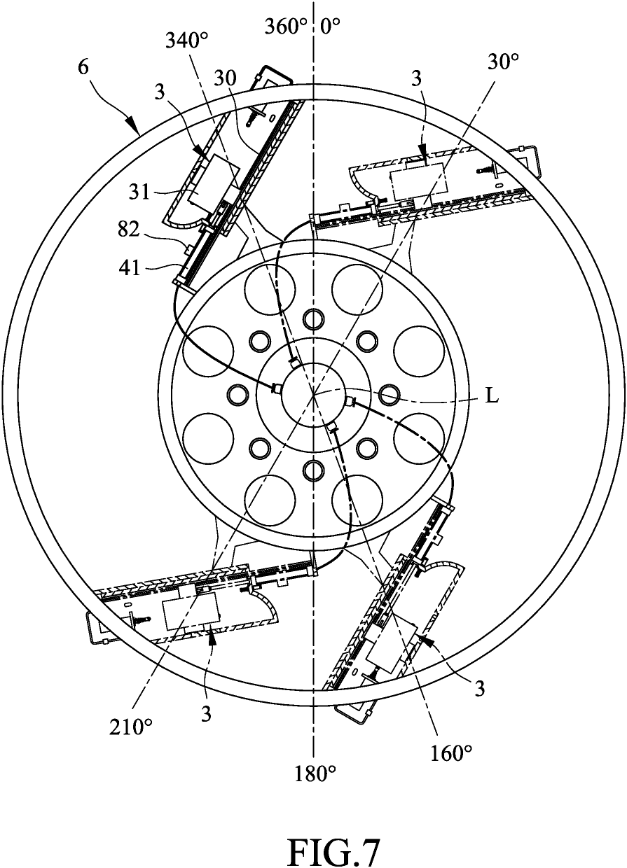

For each shifting unit 3, the main weight member 31 is slidable along the linear rail 30, via the sliding block section 319 thereof, in a direction that is perpendicular to a direction of the axis (L) and that is different from the radial direction of the rotating wheel 21 of the rotating unit 2. By virtue of the main weight members 31 being respectively movable along the linear rails 30, the center of gravity of the assembly of the rotating unit 2 and the shifting units 3 is shifted away from the axis (L) when an external force is exerted on one of the main weight members 31 and urges the one of the main weight members 31 to move. In addition, the pneumatic motion system may further include an infrared sensor (not shown) that is signally coupled to the controller 43 of the actuator unit 4, and that is operable to detect the position of each of the shifting units 3 (i.e., to monitor the movement of each of the shifting units 3) and cooperate with the controller 43 in controlling the pneumatic cylinders 41 of the actuator unit 4. In FIG. 7, to illustrate the movement of each of the shifting units 3 when the rotating unit 2 rotates, a full rotation (i.e., 360 degrees) of each of the shifting units 3 is defined as a movement cycle of the shifting unit 3. In this embodiment, the rotating unit 2 rotates clockwise when the pneumatic motion system is viewed from the front, and each of the shifting units 3 is defined to respectively be at a 0-degree position (i.e., 360-degree position) when closer to a top end of the pneumatic motion system and at a 180-degree position when closer to a bottom end of the pneumatic motion system.

When one of the shifting units 3 is at a 340-degree position, the main weight member 31 thereof is configured to be at an initial position, and the corresponding solenoid valves 82 allows the fluid flow in the respective one of the pneumatic cylinders 41. When the one of the shifting units 3 is at a 30-degree position, the controller 43 controls the respective one of the pneumatic cylinders 41 to urge the main weight member 31 of the one of the shifting units 3 to move along the linear rail 30 of the shifting unit 3 toward the one of the opposite ends of the respective one of the casings 23 distal from the rotating wheel 21. When the one of the shifting units 3 is rotated from the 30-degree position to a 160-degree position, the main weight member 31 thereof is kept moving toward the one of the opposite ends of the respective one of the casings 23 by the respective one of the pneumatic cylinders 41. When the one of the shifting units 3 is rotated to a 210-degree position, the main weight member 31 thereof is moved away from the one of the opposite ends of the casing 23 by the respective one of the pneumatic cylinders 41 and by gravity to the initial position. At this time, because the center of gravity of the assembly of the rotating unit 2 and the shifting units 3 has been shifted away from the axis (L) via the movements of the main weight members 31 of the shifting units 3, the rotating wheel 21 keeps rotating. During the movement of the one of the shifting units 3 from the 210-degree position to the 340-degree position, the main weight member 31 thereof is moved toward the other one of the opposite ends of the respective one of the casings 23 proximate to the rotating wheel 21, and then is moved away from the other one of the opposite ends of the casing 23 by the respective one of the pneumatic cylinders 41. When the one of the shifting units 3 returns to the 340-degree position, the main weight member 31 thereof returns to the initial position. That is to say, during the movement cycle of one of the shifting units 3 that starts from the 340-degree position of the shifting unit 3, the main weight member 31 of the shifting unit 3 is moved from the initial position to the one of the opposite ends of the respective one of the casings 23 distal from rotating wheel 21, from the one to the other one of the opposite ends of the casing 23, and from the other one of the opposite ends of the casing 23 to the initial position.

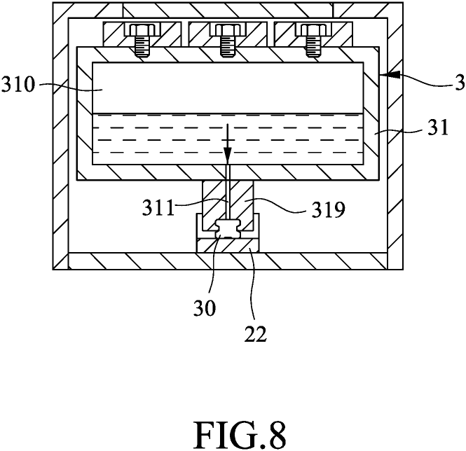

Referring further to FIG. 8, in cooperation with FIGS. 2 and 9, to ensure that the shifting units 3 operate functionally (i.e., the main weight members 31 smoothly move along the linear rails 30, respectively) under long-term operations, a portion of a lubricant is applied on the linear rails 30 and another portion of the lubricant is stored in the lubrication spaces 310 of the main weight members 31. When one of the shifting units 3 is rotated to a position at which the lubrication space 310 of the main weight member 31 of the one of the shifting units 3 is higher than the sliding block section 319 of the main weight member 31 of the shifting unit 3 relative to the ground, a proper amount of the portion of the lubricant in the shifting unit 3 flows downwardly through the lubricant outlet opening 311 of the shifting unit 3 and lubricates the sliding block section 319 and the linear rail 31 of the shifting unit 3. Therefore, lubrication between the linear rail 31 and the sliding block section 319 of each of the shifting units 3 is operated automatically as long as there is lubricant left in the lubrication space 310 of the shifting unit 3, which reduces the frequency of carrying out maintenance checks on the pneumatic motion system (i.e., the pneumatic motion system does not need to be turned off frequently for maintenance checks). In addition, when one of the shifting units 3 is rotated to a position at which the lubrication space 310 of the main weight member 31 of the one of the shifting units 3 is lower than the sliding block section 319 of the main weight member 31 of the shifting unit 3 relative to the ground, a proper amount of the portion of the lubricant on the linear rail 30 of the shifting unit 3 may flow downwardly through the lubricant outlet opening 311 of the shifting unit 3 and may be stored in the lubrication space 310 of the shifting unit 3. It is noted that, via the window 232 of each of the casings 23, when there is lubricant leakage, it may be instantly detected, and the fault causing the leakage may be fixed promptly to keep the pneumatic motion system operating functionally.

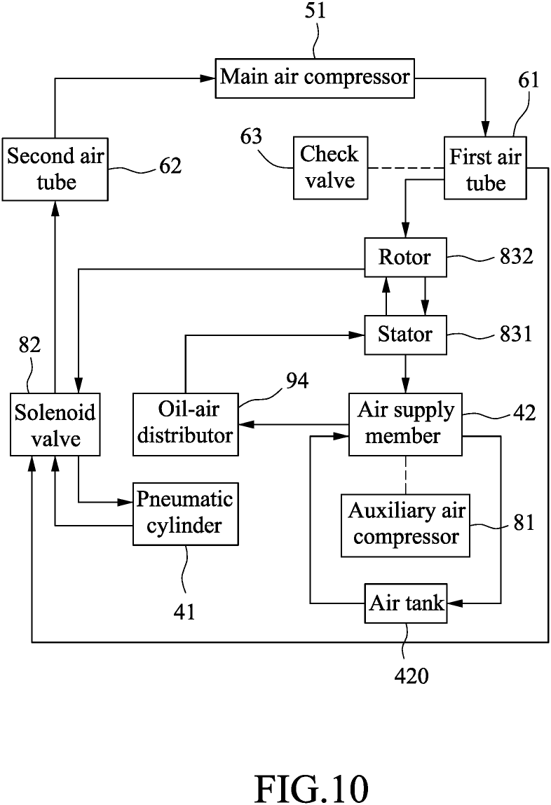

Referring further to FIG. 10, which illustrates the circulation of air in the pneumatic motion system, in the movement cycle of each of the shifting units 3, the main weight member 31 thereof is moved to the one of the opposite ends of the respective one of the casings 23 and presses the main air compressors 51 of the respective one of the air cycle units 5. When the main air compressors 51 of the respective one of the air cycle units 5 are pressed, air in the main air compressors 51 is forced to sequentially pass through the first air tubes 61, the rotor 832 and the stator 831 of the rotary union 83, and is then forced into the air supply member 42 of the actuator unit 4. Afterwards, the air that is forced into the air supply member 42 is urged to enter the oil-air distributor 94 and then be distributed to the stator 831 by the oil-air distributor 94. When the solenoid valves 82 allow the fluid flows in the pneumatic cylinders 41, the air that is distributed to the stator 831 is supplied to the pneumatic cylinders 41 through the rotor 832 for the operation of the pneumatic cylinders 41. Moreover, by virtue of the second air tubes 62 of the communicating unit 6 fluidly communicating with the main air compressors 51 and the pneumatic cylinders 41, when the pneumatic cylinders 41 release air during operation, the air released by the pneumatic cylinders 41 passes through the second air tubes 62, and is sucked by the main air compressors 51 when the push rods 512 of the main air compressors 51 are moved away from the main bodies 511 of the main air compressors 51. Therefore, the pneumatic motion system may functionally operate. It is noted that, in one embodiment, the air supply member 42 may be connected to a plurality of air tanks 420 (only one is shown in FIG. 10) when additional air input is required due to unforeseen circumstances.

To sum up, by virtue of the pneumatic cylinders 41 of the actuator unit 4 urging the main weight members 31 of the shifting units 3 to respectively move along the linear rails 30 of the shifting units 3, the center of gravity of the assembly of the rotating unit 2 and the shifting units 3 is shifted away from the axis (L), which urges the rotating unit 2 to rotate. In addition, because air in the main air compressors 51 of the air cycle units 5 is forced to pass through the first air tubes 61 of the communicating unit 6 when the main air compressors 51 are pressed by the main weight members 31, the air is returned to the air supply member 42 of the actuator unit 4 and is supplied to the pneumatic cylinders 41 for the operation of the pneumatic cylinders 41. Consequently, the pneumatic motion system converts potential energy into kinetic energy by a sustainable medium and recycles a portion of the kinetic energy (via the air cycle units 5) for driving the actuator unit 4, and the purpose of the disclosure is certainly fulfilled.

In the description above, for the purposes of explanation, numerous specific details have been set forth in order to provide a thorough understanding of the embodiment. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what is considered the exemplary embodiment, it is understood that this disclosure is not limited to the disclosed embodiment but is intended to cover various arrangements included within the spirit and scope of the broadest interpretation so as to encompass all such modifications and equivalent arrangements.

What is claimed is:

1. A pneumatic motion system comprising:
a base unit;
a rotating unit rotatably mounted to said base unit, and including
a rotating wheel that is rotatable relative to said base unit about an axis,
a plurality of casings that are mounted to said rotating wheel and that are angularly spaced apart from each other about the axis, each of said casings defining a casing space therein, and
a plurality of frame members each of which is mounted to said rotating wheel and extends in a direction different from a radial direction of said rotating wheel into said casing space of a respective one of said casings;
a plurality of shifting units each of which includes
a linear rail that is mounted to a respective one of said frame members and that extends along the respective one of said frame members, and
a hollow main weight member that is movably mounted to said linear rail, that is located in said casing space of a respective one of said casings, that defines a lubrication space adapted for storing a lubricant therein, and that has at least one lubricant outlet opening fluidly communicating with said lubrication space and opening toward said linear rail such that the lubricant lubricates said linear rail;
an actuator unit connected to said shifting units and including
a plurality of pneumatic cylinders, said main weight member of each of said shifting units being connected to at least one of said pneumatic cylinders,
at least one air supply member that fluidly communicates with said pneumatic cylinders, and
a controller that is signally coupled to said pneumatic cylinders and that is operable to control said pneumatic cylinders to urge said main weight members of said shifting units to respectively move along said linear rails of said shifting units so as to shift a center of gravity of an assembly of said rotating unit and said shifting units away from the axis; and
a plurality of air cycle units each of which is disposed at one of two opposite ends of a respective one of said casings of said rotating unit and includes two main air compressors that are spaced apart from each other and that fluidly communicate with said at least one air supply member of said actuator unit, for each casing of said rotating unit, when said main weight member of the respective one of said shifting units is moved to the one of said opposite ends of said casing, each of said main air compressors being pressed by said main weight member to force air into said at least one air supply member.

2. The pneumatic motion system as claimed in claim 1, wherein each of said main air compressors of said air cycle units includes
a main body,
a push rod that extends from said main body toward the other one of said opposite ends of the respective one of said casings,
a contact member that is disposed on one end of said push rod opposite to said main body, and
an elastic member that is sleeved on said push rod and that has two opposite ends respectively abutting against said main body and said contact member, for each casing of said rotating unit, when each of said main air compressors is pressed by said main weight member of the respective one of said shifting units, said push rod of said main air compressor being pushed toward said main body of said main air compressor and said elastic member of said main air compressor being compressed and providing a restoring force for said push rod to move away from said main body.

3. The pneumatic motion system as claimed in claim 1, further comprising a communicating unit that surrounds the axis, that is mounted to said casings of said rotating unit, that is connected to said air cycle units, and that includes
a plurality of first air tubes fluidly communicating with said main air compressors of said air cycle units and said at least one air supply member of said actuator unit, and
a plurality of second air tubes fluidly communicating with said main air compressors, said first air tubes and said second air tubes being arranged in an alternating arrangement.

4. The pneumatic motion system as claimed in claim 1, wherein said main weight member of each of said shifting units further has a lubricant inlet opening, and a lid that removably blocks said lubricant inlet opening.

5. The pneumatic motion system as claimed in claim 1, wherein each of said shifting units further includes at least one auxiliary weight member that is removably attached to said main weight member thereof.

6. The pneumatic motion system as claimed in claim 5, wherein each of said casings of said rotating unit includes at least one gate member that is operable to open such that said at least one auxiliary weight member of the respective one of said shifting units is accessible.

7. The pneumatic motion system as claimed in claim 1, wherein each of said casings of said rotating unit has two opposite ends that are respectively proximate to and distal from said rotating wheel of said rotating unit, and includes a window that is close to one of said opposite ends distal from said rotating wheel, and that is configured to be made of a transparent material.

8. The pneumatic motion system as claimed in claim 1, wherein:
said casings of said rotating unit are equiangularly spaced apart from each other about the axis, the number of said casings of said rotating unit being odd; and
the number of said frame members of said rotating unit is equal to that of said casings.

9. The pneumatic motion system as claimed in claim 8, wherein:
the number of said casings of said rotating unit is nine; and
the number of said frame members of said rotating unit is nine.

10. The pneumatic motion system as claimed in claim 1, wherein said main weight member of each of said shifting units further has a sliding block section that protrudes away from said lubrication space and that is slidably mounted to said linear rail of said shifting unit.
